(19) United States
(12) Patent Application Publication
(10) Pub. No.: US 2010/0330920 A1
(43) Pub. Date: Dec. 30, 2010

(54) PROVIDING IMPROVED CONNECTION FAILURE DETECTION

(75) Inventors: Jarkko Tuomo Koskela, Oulu (FI); Lars Dalsgaard, Oulu (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/740,913

(22) PCT Filed: Oct. 30, 2008
(86) PCT No.: PCT/IB2008/054530

§ 371 Date: Jun. 25, 2010

Related U.S. Application Data
(60) Provisional application No. 61/001,194, filed on Oct. 30, 2007.

(51) Int. Cl. H04B 17/00

(52) U.S. Cl. 455/67.11

(57) ABSTRACT

In accordance with the exemplary embodiments of the invention there is a method, an executable computer program, and apparatus for implementing a radio link failure counter that operates as a function of a discontinuous reception schedule of an active wireless communication connection, and based on a value of the radio link failure counter, determining a condition of the active wireless communication connection.

### TECHNICAL FIELD:

The exemplary and non-limiting embodiments of this invention relate generally to wireless communication systems, apparatus, methods and computer program products and, more specifically, relate to connection failure detection.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations are utilized herein:
3G third generation of GSM-based mobile networks
ARQ automatic repeat request
ASIC application specific integrated circuit
AT allocation table
DL downlink (Node B to UE)
DRX discontinuous reception
DSCCH downlink shared control channel
E-UTRAN evolved universal terrestrial radio access network
GPRS general packet radio services
GSM global system for mobile communication
HARQ hybrid automatic repeat request
HO handover
L1 layer 1 (physical layer, PHY)
L2 layer 2 (medium access control, MAC)
LTE long term evolution of UTRAN (E-UTRAN)
Node B base station
PDCCH physical downlink control channel
RAT radio access technology
RLF radio link failure
SACCH slow associated control channel
SIB system information block
UE user equipment, such as a mobile station or mobile terminal
UTRAN universal terrestrial radio access network

Detecting a connection failure between a UE and a Node B can be important. For example, if a connection failure is not detected, the UE may stay in a cell or RAT even though it cannot properly transmit messages due to the lost connection. Furthermore, the UE cannot properly receive messages from the network (i.e., the Node B). In contrast, if the connection failure is detected, the UE could react by changing to another cell or RAT.

One way to implement connection failure detection, and as specified in 3G at the time of this application, is to define a timer for determining whether the connection has been lost. If the timer expires before a suitable message or acknowledgement has been received, the connection may be deemed lost.

By way of further example, in GSM dedicated mode and GSM packet switched mode (GPRS), a so-called RLF procedure is applied. The UE detects a connection failure based on erroneous DL signaling (i.e., a success rate of decoding messages on the downlink SACCH). If the UE is unable to decode a SACCH message, a counter (radio link counter) is decreased by 1. In the event of a successful reception of a SACCH message, the counter is increased by 2. If the counter reaches 0, a RLF is declared and corresponding action is taken.

Reference in this regard may be made to Section 5 of 3GPP TS 45.008 V7.9.0 (2007-08), “3rd Generation Partnership Project; Technical Specification Group GSM/EDGE Radio Access Network; Radio subsystem link control (Release 7),” Sep. 25, 2007. Reference in regard to the action taken based on a RLF detected in accordance with TS 45.008 V7.9.0 may be made to:

3GPP TS 44.018 V7.10.0 (2007-09), “3rd Generation Partnership Project; Technical Specification Group GSM/EDGE Radio Access Network; Mobile radio interface layer 3 specification; Radio Resource Control (RRC) protocol (Release 7),” Sep. 25, 2007, and

3GPP TS 44.118 V7.2.0 (2007-06), “3rd Generation Partnership Project; Technical Specification Group GSM/EDGE Radio Access Network; Mobile radio interface layer 3 specification; Radio Resource Control (RRC) protocol; Iu mode (Release 7),” Jun. 13, 2007.

As stated in Section 5.2 of TS 45.008, one exemplary goal of determining RLF in the UE is “to ensure that calls with unacceptable voice/data quality, which cannot be improved either by [radio frequency] power control or handover, are either re-established or released in a defined manner.” This section further explains: “In general the parameters that control the forced release should be set such that the forced release will not normally occur until the call has degraded to a quality below that at which the majority of subscribers would have manually released. This ensures that, for example, a call on the edge of a radio coverage area, although of bad quality, can usually be completed is the subscriber wishes.”

### SUMMARY

In an exemplary aspect of the invention, there is a method comprising implementing a radio link failure counter that operates as a function of a discontinuous reception schedule of an active wireless communication connection, and based on a value of the radio link failure counter, determining a condition of the active wireless communication connection.

In an exemplary aspect of the invention, there is a computer readable medium encoded with a computer program executable by a processor to perform actions comprising implementing a radio link failure counter that operates as a function of a discontinuous reception schedule of an active wireless communication connection, and based on a value of the radio link failure counter, determining a condition of the active wireless communication connection.

In another exemplary aspect of the invention, there is an apparatus comprising a receiver and a transmitter configured to communicate over an active wireless communication connection, a processor configured to implement a radio link failure counter that operates as a function of a discontinuous reception schedule of the active wireless communication connection, and the processor configured to, based on a value of the radio link failure counter, determine a condition of the active wireless communication connection.

In still another exemplary aspect of the invention, there is an apparatus comprising means for communicating over an active wireless communication connection, means for implementing a radio link failure counter that operates as a function of a discontinuous reception schedule of the active wireless communication connection, and means, based on a value of the radio link failure counter, for determining a condition of the active wireless communication connection.

Wherein the exemplary aspect of the invention above, the means for communicating comprises a receiver and a transmitter, and the means for implementing and determining comprises a processor.

### BRIEF DESCRIPTION OF THE DRAWINGS:

In the attached Drawing Figures:

FIG. 1 shows a simplified block diagram of various electronic devices that are suitable for use in practicing the exemplary embodiments of this invention;

FIG. 2 depicts timing charts illustrating a first non-limiting exemplary embodiment of the invention;

FIG. 3 shows timing charts illustrating a second non-limiting exemplary embodiment of the invention;

FIG. 4 depicts timing charts illustrating a third non-limiting exemplary embodiment of the invention;

FIG. 5 depicts a flowchart illustrating one non-limiting example of a method for practicing the exemplary embodiments of this invention; and

FIG. 6 depicts a flowchart illustrating another non-limiting example of a method for practicing the exemplary embodiments of this invention.

### DETAILED DESCRIPTION:

In LTE (E-UTRAN), at the time of this application, no particular technique has been specified for a UE in LTE_ACTIVE to detect that the current connection between the UE and the network is breaking or has been lost. As previously noted, this could have the consequence that the UE stays in an LTE cell or in LTE without being able to transmit data and without being able to receive messages from the network (i.e., messages intended for that UE). In LTE_ACTIVE, mobility utilizes a network-controlled UE-assisted handover. Thus, there is a need to specify how a UE should detect a condition of the current connection and/or detect a connection failure (i.e., RLF) and what the UE should do in response to detecting connection failure (i.e., in response to RLF).

The captured agreements, at the time of this application, with respect to DRX for active communications in E-UTRAN (e.g., RRC_CONNECTED) may be found in Section 12, “DRX in RRC_{—} CONNECTED,” of 3GPP TS 36.300 Vdraft8.2.0 (2007-09), “3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 8), October 2007.

It is briefly noted that an active mode or active communication link (e.g., LTE ACTIVE) is significantly different from a passive or idle mode. In an active mode, the UE is transmitting and receiving, for example, in accordance with scheduled resources that may include a DRX interval (e.g., for power savings). In an idle mode, the UE is not actively communicating and generally does not seek to undertake bidirectional communication, for example, with a network. While in an idle mode utilizing DRX, the UE may “wake up” periodically and check a paging channel to determine if it should initiate an active connection (e.g., to check if the UE has been assigned resources for an active communication, such as a phone call). Generally, an active mode DRX interval is shorter than an idle mode DRX interval. As non-limiting examples, an active mode DRX interval may be on the order of (i.e., about) 20-100 ms whereas an idle mode DRX interval may be on the order of (i.e., about) 1-1.5 seconds.

LTE specifies a packet system wherein, at least in some proposals, the nature of the connection will vary depending on the service running. Thus, the service currently in use will influence the DRX and scheduling needs of the UE. In other conventional non-LTE systems, actual RLF is usually determined on the UE side by evaluating the quality (e.g., loss) of scheduling commands.

One technique that could be utilized for LTE would be to define a fixed timer for determining RLF, similar to the one specified for 3G (e.g., GPRS), as described above. However, a fixed-length timer such as that in GPRS would not be an appropriate solution if the connection utilizes flexible packet scheduling (e.g., a DRX scheme in LTE ACTIVE), as proposed in some concepts. For example, UEs using different DRX parameters would behave differently. If the RLF timer is defined incorrectly for a given UE's DRX scheme, the UE may trigger RLF too early (e.g., when RLF actually does not exist) or too late (e.g., taking too long to detect RLF). This could lead, for example, to incorrect actions taking place (e.g., based on incorrect detection of RLF) or loss of air interface resources.

Reference in regard to other exemplary RLF techniques may be made to commonly-assigned European Patent (EP) No. 1 264 504 B1 to Vialen et al., titled “Method and Arrangement for Optimizing the Re-Establishment of Connections in a Cellular Radio System Supporting Real Time and Non-Real Time Communications,” issued Sep. 12, 2007.

Claim 1 of EP 1 264 504 B1 recites: “A method for determining the expiry time for a period during which the re-establishment of a lost radio connection between a mobile station and a network node of a cellular radio network including at least one radio bearer, is allowable, characterized in that it comprises the steps of: determining a first expiry time (206, 207) for a period during which the re-establishment of the lost radio connection in respect of radio bearers used to provide a service or services of a first category is allowable and determining a second expiry time (208, 209) for a period during which the re-establishment of the lost radio connection in respect of radio bearers used to provide a service or services of a second category is allowable.”

Exemplary embodiments of this invention propose connection failure detection techniques that utilize current connection settings of a flexible schedule connection (e.g., DRX settings and parameters for an active communication of a UE) to provide more accurate RLF detection.

While described herein with specific reference to DRX settings, scheduling and parameters for a given UE, the exemplary embodiments of the invention are not limited thereto and may be used to advantage in other contexts, for example, when the RLF detection technique is influenced by one or more settings, schedules and/or parameters that a UE is utilizing for a flexible scheduling connection. Similarly, while described herein primarily with reference to an active mode or an active communication link, the exemplary embodiments of the invention are not limited thereto and may be used to advantage in other contexts.

While exemplary embodiments of the invention are primarily discussed with respect to implementation by a UE, they are not limited only thereto, and may be implemented by any suitable communication device or component, including a relay node, Node B or other network component.

Furthermore, while various exemplary embodiments are described below in the context of the E-UTRAN (UTRAN-LTE) system, it should be appreciated that the exemplary embodiments of this invention are not limited for use with only this one particular type of wireless communication system, and that they may be used to advantage in other wireless communication systems.

As utilized herein, a “timer” is considered to be a particular type or subset of “counter” that counts up or down based on time (i.e., the progression of time). For example, a counter may count (up or down) based on a trigger (e.g., received messages, errors, erroneous receptions) that one of increments or decrements the counter. A counter further may be utilized in view of a maximum and/or minimum. A counter also may be implemented in view of one or more actions that occur in response to the counter meeting, exceeding or falling below one or more threshold values (e.g., a maximum value or a minimum value). A counter may also be implemented whereby the value of the counter is decremented or incremented in the reverse direction in response to a positive stimulus (e.g., correctly-received messages, error-free decoding).

### I. General Description

The exemplary embodiments of the invention provide a RLF counter (e.g., a RLF timer) that takes into account flexible scheduling (e.g., flexible packet scheduling, DRX interval for an active communication link). In one, non-limiting exemplary embodiment, a RLF timer is linked (e.g., based on, dependent on) a currently-applied DRX interval of an active connection between a UE and a network. In such a manner, the RLF timer for a respective UE will vary according to the DRX settings and scheduling utilized by the UE. For example, if the UE is assigned a long DRX interval and is rarely scheduled, the counter/timer will be long. In contrast, if the UE is assigned a short DRX interval and is often scheduled, the counter/timer will be shorter.

In further exemplary embodiments, a UE that detects RLF will revert to a predefined DRX interval. The predefined DRX interval is specified in order to provide the UE with an optimal chance to re-gain service either within the current serving cell or with other cells (e.g., within or outside LTE).

By way of further discussion, assume an example wherein a UE is assigned, by a network, a regular DRX period of 100 ms. The UE will receive a DSCCH, an AT or a L1/L2 signaling channel every 100 ms (the DRX period) in order to determine if resources have been assigned to the UE. Assuming the UE receives the DSCCH, correct reception of the DSCCH is essential for UE operation in the cell. If the DSCCH cannot be received correctly, the UE cannot detect whether resources are assigned to it. This could lead to waste of air interface resources and potentially a situation where the UE is not reachable for a long period of time.

Thus, in this example one possible trigger for detecting RLF could be erroneous reception of the DSCCH. Another example of a trigger for detecting RLF is erroneously received data (before or after HARQ retransmissions). The latter may be more suitable, for example, in the case of a fully persistent allocation without DSCCH signaling. A third example of a trigger is to use or define a minimum received signal level from the serving cell as a definition for when DL data/signaling is possible (e.g., a threshold signal level above which DL data and/or signaling is enabled).

As the reception of DSCCH/data depends on or is linked to DRX, it is proposed that the RLF counter/timer trigger depend on or be linked to the given DRX period or settings for the current connection (e.g., current active connection). In this case, DRX signifies those pre-established time intervals in which the UE would receive either DSCCH, DL data, an AT or a L1/L2 signaling channel.

In response to determining (e.g., detecting) RLF, the UE may implement RLF procedures. As a non-limiting example, and as described in further detail below, a UE that detects RLF may revert to a predefined DRX interval. As further non-limiting examples, a UE that detects RLF may attempt to connect with a different cell, on a different frequency band or using a different RAT (e.g., a non-LTE RAT if the previous connection used LTE). The specific RLF procedures may be provided in a specification or standard, as non-limiting examples, and may depend on the particular RAT that was previously in use for the connection.

As a non-limiting example, if the RLF counter is implemented in a relay node, Node B or other network device, in response to determining RLF, the device may free resources previously assigned for the UE and/or stop attempting to communicate with the UE.

### II. Short and Long DRX

Before discussing various exemplary embodiments of the invention, it may be useful to further describe one specific, non-limiting example of DRX implementation. In some concepts, the DRX comprises at least two parts: regular DRX (also referred to herein as “long” DRX) and interim DRX (also referred to herein as “short” DRX). Regular DRX may be based on the basic connection requirements of the UE. In contrast, interim DRX may be used for providing faster data throughput (an increase in data throughput) based on the needs of the UE (e.g., communication or media type—what the connection is being used for by the UE). Applying short DRX to an ongoing communication link will increase the UE's DRX receptions (e.g., the UE's reception of DSCCH or data), for example, for checking of possible resource allocations.

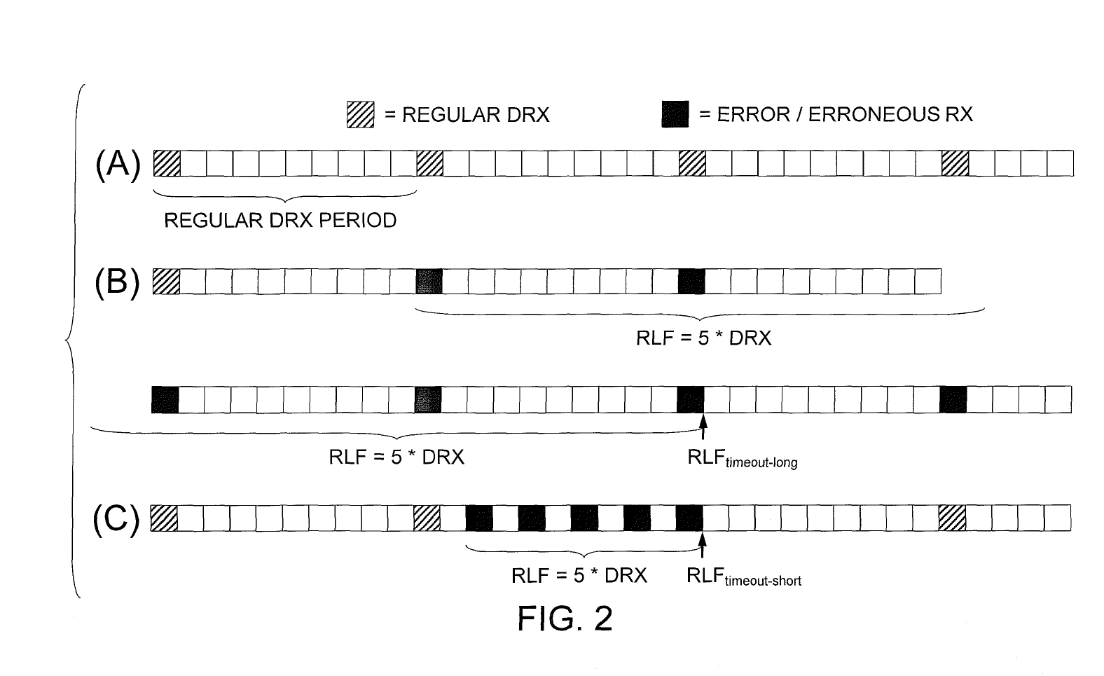

As a non-limiting example, short DRX may be based on a predetermined short DRX period corresponding to a given long DRX period. For example, if the long DRX has a period of every tenth frame (see FIG. 2A), the short DRX may have a period of every other frame (see FIG. 2C). As another non-limiting example, the short DRX period may be specified independent of the long DRX period. For example, regardless of the long DRX period (e.g., every fifth frame, every tenth frame), the short DRX period may always be every other frame. The specific relationship between the long DRX period and the short DRX period may comprise any suitable relationship so long as the short DRX period is smaller (e.g., provides a higher throughput and/or increases the scheduling options for resource allocations) than the long DRX period.

Even if the communication system does not utilize a multi-form DRX (e.g., short/long), the examples provided herein concerning long and short DRX instead may be viewed as corresponding to two different DRX periods. The issues highlighted by examples with long and short DRX are equally valid and may be discussed in reference to different DRX periods, such as one that is substantially shorter than another. Similarly, the examples are also valid when utilizing one DRX period and applying the on-duration and/or inactivity-timer, as further discussed in section 12 of 3GPP TS 36.300 Vdraft8.2.0.

### III. Exemplary Devices

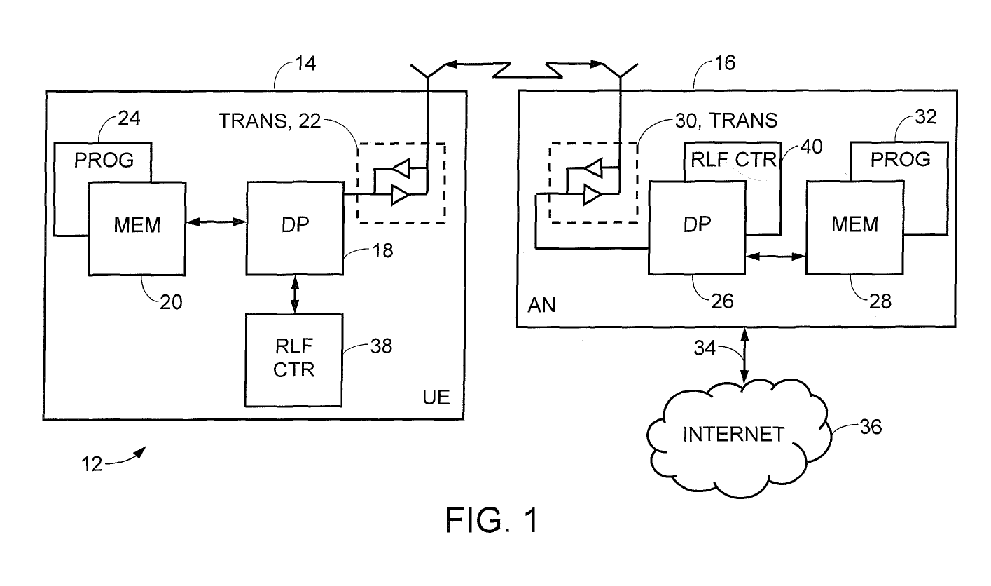

Reference is made to FIG. 1 for illustrating a simplified block diagram of various electronic devices that are suitable for use in practicing the exemplary embodiments of this invention. In FIG. 1, a wireless network 12 is adapted for communication with a user equipment (UE) 14 via an access node (AN) 16.

The UE 14 includes a data processor (DP) 18, a memory (MEM) 20 coupled to the DP 18, and a suitable RF transceiver (TRANS) 22 (having a transmitter (TX) and a receiver (RX)) coupled to the DP 18. The MEM 20 stores a program (PROG) 24. The TRANS 22 is for bidirectional wireless communications with the AN 16. Note that the TRANS 22 has at least one antenna to facilitate communication. The UE 14 also includes a RLF counter (RLF CTR) 38. The RLF counter 38 operates as a function of a flexible scheduling (e.g., DRX interval) of the active wireless communication connection between the UE 14 and the AN 16. RLF of the connection is determined based on a value of the RLF counter 38 as further described herein. Although shown in FIG. 1 as a separate component (e.g., a circuit, an ASIC, another specialized chip or component) coupled to the DP 18, the RLF counter 38 may comprise a function implemented by the DP 18, a value resident in the MEM 20 and manipulated by the DP 18 or PROG 24 or a function implemented by the PROG 24, as non-limiting examples.

The AN 16 includes a data processor (DP) 26, a memory (MEM) 28 coupled to the DP 26, and a suitable RF transceiver (TRANS) 30 (having a transmitter (TX) and a receiver (RX)) coupled to the DP 26. The MEM 28 stores a program (PROG) 32. The TRANS 30 is for bidirectional wireless communications with the UE 14. Note that the TRANS 30 has at least one antenna to facilitate communication. The AN 16 is coupled via a data path 34 to one or more external networks or systems, such as the Internet 36, for example.

As shown in FIG. 1, the AN 16 includes a RLF counter (RLF CTR) 40. The RLF counter 40 operates as a function of a flexible scheduling (e.g., DRX interval) of the active wireless communication connection between the UE 14 and the AN 16. RLF of the connection is determined based on a value of the RLF counter 40 as further described herein. Although shown in FIG. 1 as a separate component (e.g., a circuit, an ASIC, another specialized chip or component) coupled to the DP 26, the RLF counter 40 may comprise a function implemented by the DP 26, a value resident in the MEM 28 and manipulated by the DP 26 or PROG 32 or a function implemented by the PROG 36, as non-limiting examples. In other exemplary embodiments, the AN 16 may not comprise the RLF counter 40.

In some exemplary embodiments, at least one of the PROGs 24, 32 is assumed to include program instructions that, when executed by the associated DP, enable the electronic device to operate in accordance with the exemplary embodiments of this invention, as discussed herein.

In general, the various exemplary embodiments of the UE 14 can include, but are not limited to, terminals, mobile nodes, mobile phones, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by one or more of the DPs 18, 26 of the UE 14 and the AN 16, or by hardware, or by a combination of software and hardware.

The MEMs 20, 28 may be of any type suitable to the local technical environment and may be implemented using any suitable data storage technology, such as semiconductor-based memory devices, magnetic memory devices and systems, optical memory devices and systems, fixed memory and removable memory, as non-limiting examples. The DPs 18, 26 may be of any type suitable to the local technical environment, and may include one or more of general purpose computers, special purpose computers, microprocessors, digital signal processors (DSPs) and processors based on a multi-core processor architecture, as non-limiting examples.

### IV. Various Exemplary Embodiments

There are a number of different techniques for implementing the exemplary embodiments of the invention. Below are described a few, non-limiting examples of such techniques. From these examples, it should be apparent that any suitable technique can be used that accounts for flexible scheduling that can vary among the UEs and may affect RLF detection.

### A. First Exemplary Embodiment

In a first exemplary embodiment, RLF detection is performed in accordance with the following:

RLFₜᵢₘₑₒᵤₜ=x×DRX_intervalₜᵢₘₑᵣ (1)

DRX_interval is the scheduled UE reception interval for DRX (e.g., reception of DSCCH or data). The value x may be any suitable variable as specified by the implementation. As a non-limiting example, x may comprise a system-dependent number provided in a SIB or other signaling As a further non-limiting example, x may comprise a predetermined value that is provided by a certain specification or standard. The value for x may comprise an integer or a non-integer.

In accordance with equation (1), the RLF timeout period may be utilized for determining RLF as described in the following non-limiting, exemplary technique. RLF may be determined to be present (i.e., occurring) in response to a condition being met. The RLF condition may be evaluated every evaluation time period. The evaluation time period may comprise the RLF timeout period or be a function thereof Thus, if the evaluation trigger used for determining possible RLF occurs (meets the condition) during a predetermined time period that is based on the DRX interval, a RLF is determined. As can be seen, if x is an integer, the RLF timeout period is a multiple of the DRX interval (DRX_interval). The time in question may be defined as real time or another system-specific time (e.g., in frames), as non-limiting examples. For example, equation (1) may specify that if the UE has received erroneous DSCCH/data (for example) for a duration of RLFₜᵢₘₑₒᵤₜ, then the UE will trigger a RLF procedure.

Equation (1) may be modified to use a counter instead of a timer:

RLF_{count}(y)=RLF_{count}(y−1)+1 (2)

If RLF_{count}(y)≧MaxRLF_{count}, then initiate RLF procedure (3)

Note that y is an index that starts at 1. Equation (2) increments the RLF_{count} by 1 for each trigger occurrence. Equation (3) signifies that the UE initiates a RLF procedure when the trigger count (RLF_{count}(y)) reaches a predetermined value (MaxRLF_{count}).

FIG. 2 depicts timing charts illustrating this first exemplary embodiment of the invention. FIG. 2A shows a timing chart indicating the regularly-scheduled DRX having a regular (long) DRX period (DRX period). FIG. 2B shows a long DRX implementation where RLF_period=5×DRX_period. That is, x=5 for equation (1). For example, if no correct DRX reception takes place, or any other suitable trigger occurs (e.g., such as those identified above), during a period of time specified by RLF_period, a RLF_{timeout-long} is reached and the RLF procedure is initiated. FIG. 2C shows a short DRX implementation where RLF_period=5×DRX_period (i.e., x=5). As can be seen, and by example, a RLFₜᵢₘₑₒᵤₜ₋ₛₕₒᵣₜ is reached if no correct DRX receptions take place during a period of time specified by RLF_period. Note that erroneous DRX reception is only one, non-limiting example of a trigger occurrence and that other, different triggers may be utilized. The specific trigger (i.e., the occurrence that triggers a change in the RLF count) chosen may be dependent on the system and/or one or more system parameters, for example. Further note that use of the word “trigger” as a verb may be within the context of “triggering” (e.g., initiating) a RLF procedure due to the trigger occurring sufficient times to meet the requisite conditions (e.g., MaxRLF_{count}) for determining RLF (e.g., as represented by RLFₜᵢₘₑₒᵤₜ).

In view of equations (2) and (3), FIGS. 2B and 2C may also be interpreted, for example, as indicating that a RLF procedure is initiated if 5 erroneous DRX receptions occur (i.e., 5 erroneous receptions when the UE should correctly be receiving per the long/short DRX schedule).

It is noted that in FIGS. 2, 3 and 4, the term “RLFₜᵢₘₑₒᵤₜ” is used to indicate the initiating of the RLF procedure regardless of whether a timer or a counter is being used.

In other exemplary embodiments, the counter (RLF_{count}(y)) may be decremented for each correctly-received DRX. In such a manner, if MaxRLF_{count}=5, for example, one would need a net amount of 5 erroneous DRX receptions in order to initiate a RLF procedure.

In further exemplary embodiments, the counter may count down instead of up (e.g., decrement the counter for each erroneous reception until a MinRLF_{count} value is reached, such as counting down to 0).

As can be seen in FIG. 2, while the counter/timer is dependent on the respective DRX period or interval, the reaching of RLFₜᵢₘₑₒᵤₜ (or the initiation of RLF procedure(s) per MaxRLF_{count}) may vary substantially depending on whether long or short DRX is in use. In some exemplary embodiments, it may be more desirable to provide a more robust RLF scheme using a variable counter/timer that specifically depends on or is linked to the form of DRX in use (e.g., long or short). The second and third exemplary embodiments discussed below account for this additional consideration.

### B. Second Exemplary Embodiment

Taking the DRX (e.g., DSCCH or data) reception interval into account could be performed such that the RLF counter/timer (i.e., the MaxRLF_{count} value or the RLFₜᵢₘₑₒᵤₜ value) is relatively shorter for UEs with long DRX than for UEs with short DRX. This would effectively reduce the RLF trigger count/time for long DRX intervals while disallowing short DRX intervals from triggering too fast.

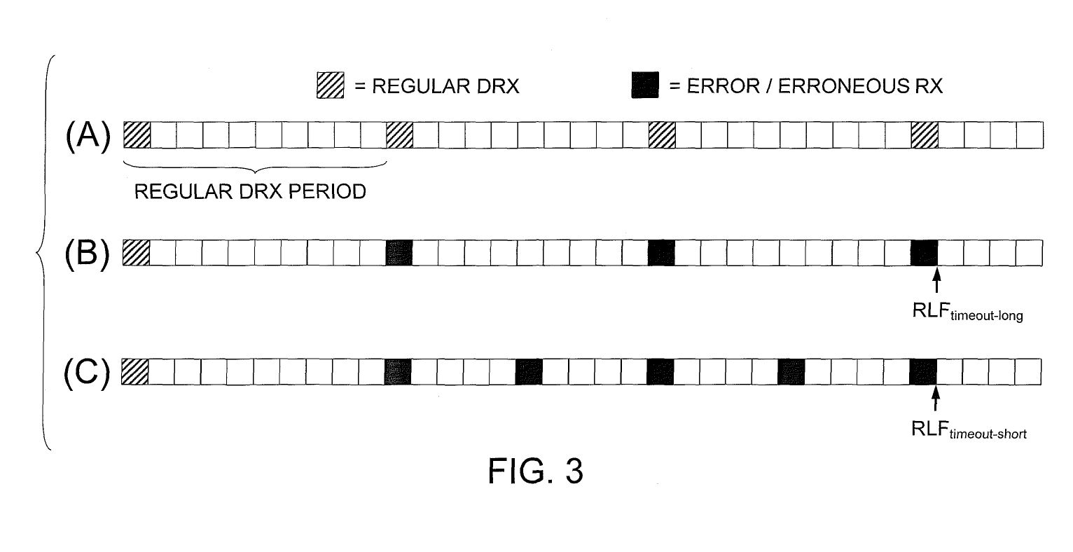

FIG. 3 shows timing charts illustrating this second non-limiting exemplary embodiment of the invention. FIG. 3A shows a timing chart indicating the regularly-scheduled DRX having a regular (long) DRX period. FIG. 2B shows a long DRX implementation (long DRX period of every tenth frame) where MaxRLF_{count-long}=3. FIG. 2C shows a short DRX implementation (short DRX period of every fifth frame) where MaxRLF_{count-short}=5. In such a manner, and as a non-limiting example, it takes 5 erroneous DRX receptions to trigger with short DRX but only 3 such erroneous receptions to trigger with long DRX.

Although the example illustrated in FIG. 3 has both RLFₜᵢₘₑₒᵤₜ values (i.e., RLF_{timeout-long} and RLFₜᵢₘₑₒᵤₜ₋ₛₕₒᵣₜ) triggering after a same amount of time has passed (e.g., without a correct DRX reception), in other exemplary embodiments this may not be the case.

Another alternative is to let the counter remain the same for all DRX intervals but allow the increment value to vary depending on or linked to the particular DRX.

RLF_{count}(y)=RLF_{count}(y−1)+N_{—}VAR (4)

In this exemplary embodiment, RLF_{count}(y) is increased by N_VAR (e.g., every time an erroneous DRX reception occurs, every time an erroneous DSCCH or data is received). N_VAR may be different for long DRX than for short DRX. For example, N_VAR may be larger for long DRX and smaller for short DRX. Thus, N_VAR could be defined separately for each form of DRX (e.g., long/short). In other exemplary embodiments, N_VAR may be a same value for multiple forms of DRX. In further exemplary embodiments, N_VAR may be given by an equation, for example:

N_{—}VAR=INTEGER(SQRT(1000×DRX_interval)) (5)

where DRX_interval corresponds to the respective DRX interval expressed in seconds. For example, using equation (5), if the last reception of DSCCH/data were 1 ms ago, then the UE would increment RLF_{count}(y) by 1 (N_VAR=1). As a further example, if the last reception of DSCCH/data occurred 100 ms ago, the UE would increment RLF_{count}(y) by 10 (N_VAR=10).

As previously noted, in other exemplary embodiments, the UE may decrease the counter (RLF_{count}(y)) by a predetermined value for every correctly-received DRX reception (e.g., every time DSCCH or data is received). In further exemplary embodiments, the value by which the counter is decremented may vary for different forms of DRX, similar to N_VAR above.

Consider FIGS. 3B and 3C in view of equation (4). Assume that the value for MaxRLF_{count} is the same for both long and short DRX and that N_VAR is different for long and short DRX. In accordance with FIG. 3, if one lets MaxRLF_{count}=3, then one has N_VAR_{long}=1 and N_VARₛₕₒᵣₜ=⅗. As an alternative, if one lets MaxRLF_{count}=5, then one has N_VAR_{long}= 5/3 and N_VARₛₕₒᵣₜ=1. As one can appreciate, the difference between these sets of values is merely in scale. The former has MaxRLF_{count} based on, for example, the number of erroneous long DRX needed to trigger RLF while the latter has MaxRLF_{count} based on, for example, the number of erroneous short DRX. Either MaxRLF_{count} value may be utilized in conjunction with exemplary embodiments of the invention.

As a further non-limiting example of a varying N_VAR, one could use:

N_{—}VAR=z×DRX_interval (6)

One may note that equation (6) is similar to equation (5). Utilizing equation (6), one has N_VAR for a short interval being less than N_VAR for a long interval. Thus, RLF_{count}(y) will increase slower for a short interval than for a long interval. The value z may be any suitable value, similar to x in equation (1). As non-limiting examples, z may comprise a system parameter set by the network or simply 1.

### C. Third Exemplary Embodiment

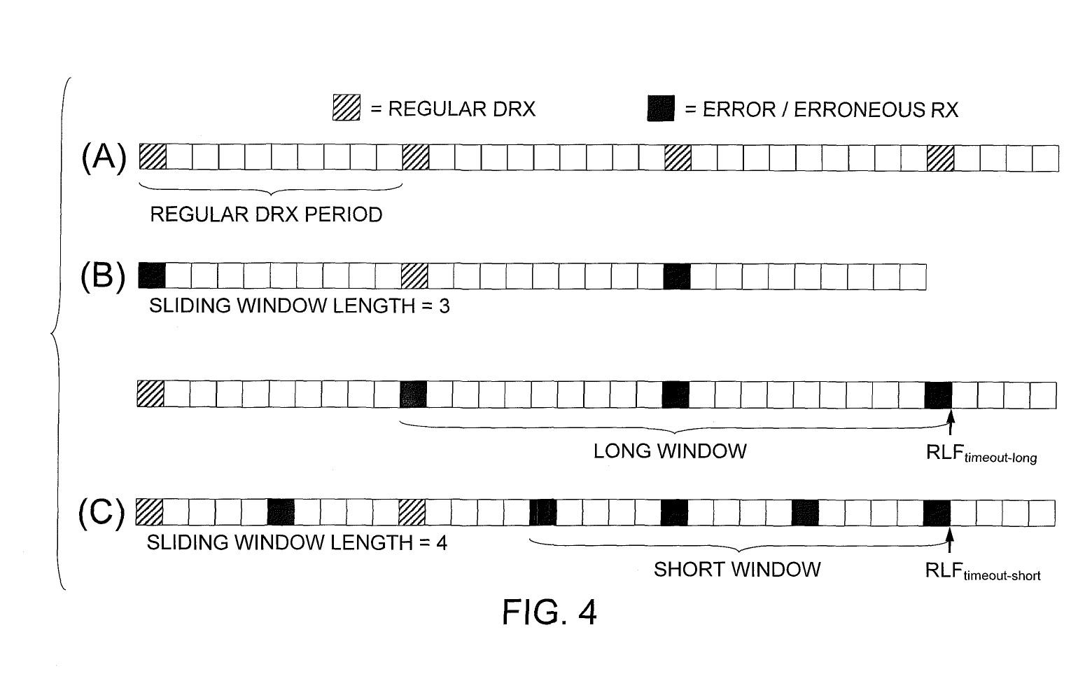

Another option for accounting for different forms of DRX is to implement a sliding window approach based on, for example, a percentage of erroneously received DRX receptions (e.g., DSCCH, data) exceeding a pre-defined limit. FIG. 4 depicts timing charts illustrating this third non-limiting exemplary embodiment of the invention. Note that the sliding window length may vary based on the form of DRX (e.g., long/short). Similarly, the triggering value (percentage) may vary based on the form of DRX (e.g., long/short).

In some exemplary embodiments, the sliding window length in time may vary (i.e., between long and short DRX), but may still cover the same number of count events and thereby be less dependent on the DRX data interval (e.g., DSCCH/data interval).

### D. Reverting to a Pre-Defined DRX Interval

As previously noted, in further exemplary embodiments, a UE that detects RLF reverts to a predefined DRX interval. The predefined DRX interval is specified in order to provide the UE with an optimal chance to re-gain service either within the current serving cell or with other cells (e.g., within or outside LTE). In some exemplary embodiments, the predefined DRX interval is known by the UE and the network in order to enable the network to reach the UE if possible (e.g., so the UE can receive possible DL resource assignments while ensuring reception gaps for the UE to perform cell searching). As a non-limiting example, the predefined DRX interval may be based on one or more rules. A non-limiting example of such a rule has the UE listening to/for the DSCCH/AT at every SFN MOD v=0, where v is provided by the network (e.g., in a SIB). As further non-limiting examples, the UE could revert to idle mode DRX settings (e.g., as defined by the corresponding specification or standard) or modulo of idle mode DRX. As another non-limiting example, when the UE and the network detect RLF, they both may start using a specific RLF DRX setting to attempt re-connection.

### E. HARQ

The exemplary embodiments of the invention may be implemented with or without taking HARQ retransmissions into account. For example, accounting for HARQ retransmissions, the references herein to DRX receptions may be interpreted as new or first DRX receptions (e.g., first reception of DSCCH). As another non-limiting example, references herein to DRX receptions may not account for HARQ retransmissions and otherwise do not distinguish between new or first transmissions and subsequent retransmissions. One reason for not taking HARQ into account would be if the network is planning to use a certain number of retransmissions in order to get the original data through (i.e., in order to assure reception of the original data).

### V. Further Descriptions of Exemplary Embodiments

Below are provided further descriptions of non-limiting, exemplary embodiments. The below-described exemplary embodiments are separately numbered for clarity and identification. This numbering should not be construed as wholly separating the below descriptions since various aspects of one or more exemplary embodiments may be practiced in conjunction with one or more other aspects or exemplary embodiments.

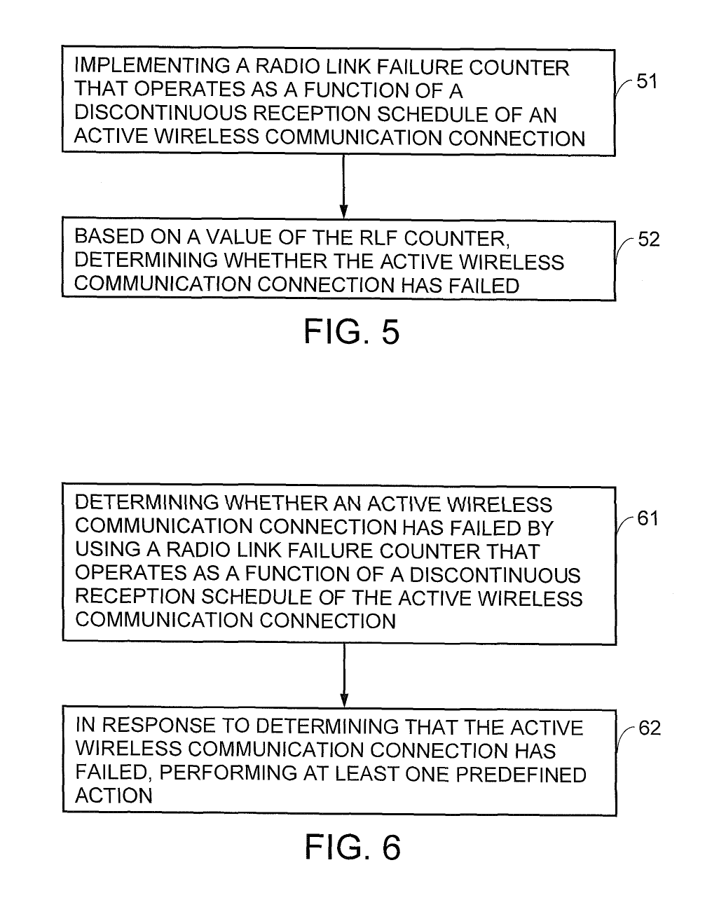

In one non-limiting, exemplary embodiment, and as illustrated in FIG. 5, a method includes: implementing a radio link failure counter that operates as a function of a discontinuous reception schedule of an active wireless communication connection (box 51); and based on a value of the RLF counter, determining whether the active wireless communication connection has failed (box 52).

A method as above, further comprising: in response to determining that the active wireless communication connection has failed, performing at least one predefined action. A method as in any above, further comprising: signaling the discontinuous reception schedule to a user equipment. A method as in any above, wherein the RLF counter is incremented or decremented in response to the occurrence of a trigger. A method as in the previous, wherein the trigger comprises erroneous reception of DSCCH or data. A method as in above, wherein the trigger comprises an event or condition linked to the discontinuous reception schedule. A method as in any above, wherein the incrementing or decrementing is performed utilizing a variable that is a function of the discontinuous reception schedule of the active wireless communication connection. A method as in any above, wherein the RLF counter utilizes a sliding window.

A method as in any above, wherein the RLF counter utilizes a percentage determination in conjunction with the sliding window. A method as in any above, wherein the active wireless communication connection utilizes ARQ or HARQ. A method as in any above, wherein the RLF counter comprises a timer. A method as in any above, wherein the RLF counter comprises a timer that operates in accordance with RLFₜᵢₘₑₒᵤₜ=x×DRX_intervalₜᵢₘₑᵣ. A method as in any above, wherein failure is determined in response to the RLF counter equaling or exceeding a maximum value or equaling or falling below a minimum value. A method as in any above, wherein the RLF counter corresponds to whether the DRX in use comprises a short DRX or a long DRX. A method as in any above, further comprising: in response to determining RLF, reverting to a predefined DRX period. A method as in any above, further comprising: in response to determining RLF, attempting to connect with a different cell, on a different frequency band or using a different RAT. A method as in any above, wherein the method is implemented within a wireless communication network. A method as in any above, wherein the method is implemented within an E-UTRAN. A method as in any above, wherein the method is implemented by a data processor of a user equipment or terminal. A method as in any above, wherein the method is implemented as a computer program.

In another non-limiting, exemplary embodiment, a computer program product comprises program instructions embodied on a tangible computer-readable medium. Execution of the program instructions results in operations comprising: implementing a radio link failure counter that operates as a function of a discontinuous reception schedule of an active wireless communication connection; and based on a value of the RLF counter, determining whether the active wireless communication connection has failed.

A computer program as above, further comprising: in response to determining that the active wireless communication connection has failed, performing at least one predefined action. A computer program as in any above, further comprising: signaling the discontinuous reception schedule to a user equipment. A computer program as in any above, wherein the RLF counter is incremented or decremented in response to the occurrence of a trigger. A computer program as in the previous, wherein the trigger comprises erroneous reception of DSCCH or data. A computer program as above, wherein the trigger comprises an event or condition linked to the discontinuous reception schedule. A computer program as in any above, wherein the incrementing or decrementing is performed utilizing a variable that is a function of the discontinuous reception schedule of the active wireless communication connection. A computer program as in any above, wherein the RLF counter utilizes a sliding window.

A computer program as in any above, wherein the RLF counter utilizes a percentage determination in conjunction with the sliding window. A computer program as in any above, wherein the active wireless communication connection utilizes ARQ or HARQ. A computer program as in any above, wherein the RLF counter comprises a timer. A computer program as in any above, wherein the RLF counter comprises a timer that operates in accordance with RLFₜᵢₘₑₒᵤₜ=x×DRX_intervalₜᵢₘₑᵣ. A computer program as in any above, wherein failure is determined in response to the RLF counter equaling or exceeding a maximum value or equaling or falling below a minimum value. A computer program as in any above, wherein the RLF counter corresponds to whether the DRX in use comprises a short DRX or a long DRX. A computer program as in any above, further comprising: in response to determining RLF, reverting to a predefined DRX period. A computer program as in any above, further comprising: in response to determining RLF, attempting to connect with a different cell, on a different frequency band or using a different RAT. A computer program as in any above, wherein the computer program is implemented within a wireless communication network. A computer program as in any above, wherein the method is implemented within an E-UTRAN. A computer program as in any above, wherein the computer program is executed by a data processor of a user equipment or terminal.

In another non-limiting, exemplary embodiment, an apparatus comprising: a transceiver; a radio link failure counter that operates as a function of a discontinuous reception schedule of an active wireless communication connection carried out by the transceiver; and a processor configured, based on a value of the RLF counter, to determine whether the active wireless communication connection has failed.

An apparatus as above, wherein the processor is further configured, in response to determining that the active wireless communication connection has failed, to perform at least one predefined action. An apparatus as in any above, wherein the transceiver is configured to receive the discontinuous reception schedule via a wireless communication. An apparatus as in any above, wherein the RLF counter is incremented or decremented in response to the occurrence of a trigger. An apparatus as in the previous, wherein the trigger comprises erroneous reception of DSCCH or data. An apparatus as in above, wherein the trigger comprises an event or condition linked to the discontinuous reception schedule. An apparatus as in any above, wherein the incrementing or decrementing is performed utilizing a variable that is a function of the discontinuous reception schedule of the active wireless communication connection. An apparatus as in any above, wherein the RLF counter utilizes a sliding window.

An apparatus as in any above, wherein the RLF counter utilizes a percentage determination in conjunction with the sliding window. An apparatus as in any above, wherein the active wireless communication connection utilizes ARQ or HARQ. An apparatus as in any above, wherein the RLF counter comprises a timer. An apparatus as in any above, wherein the RLF counter comprises a timer that operates in accordance with RLFₜᵢₘₑₒᵤₜ=x×DRX_intervalₜᵢₘₑᵣ. An apparatus as in any above, wherein failure is determined by the processor in response to the RLF counter equaling or exceeding a maximum value or equaling or falling below a minimum value. An apparatus as in any above, wherein the RLF counter corresponds to whether the DRX in use comprises a short DRX or a long DRX. An apparatus as in any above, wherein the transceiver is configured, in response to the processor determining failure, to revert to a predefined DRX period. An apparatus as in any above, wherein the transceiver is configured, in response to the processor determining RLF, to attempt to connect with a different cell, on a different frequency band or using a different RAT. An apparatus as in any above, wherein the apparatus comprises a node of a wireless communication network. An apparatus as in any above, wherein the apparatus comprises a node of an E-UTRAN. An apparatus as in any above, wherein the apparatus comprises a user equipment or terminal. An apparatus as in any above, wherein apparatus comprises a mobile phone.

In another non-limiting, exemplary embodiment, an apparatus comprising: means for communicating; means for counting as a function of a discontinuous reception schedule of an active wireless communication connection carried out by the means for communicating; and means for determining, based on a value of the means for counting, whether the active wireless communication connection has failed.

An apparatus as above, wherein the means for communicating comprises a transceiver, the means for counting comprises a RLF counter, and the means for determining comprises a processor. An apparatus as in any above, wherein the apparatus comprises a user equipment or terminal.

In another non-limiting, exemplary embodiment, and as shown in FIG. 6, a method comprising: determining whether an active wireless communication connection has failed by using a radio link failure counter that operates as a function of a discontinuous reception schedule of the active wireless communication connection (box 61); and in response to determining that the active wireless communication connection has failed, performing at least one predefined action (box 62).

A method as above, and further comprising one or more of the various aspects of the exemplary embodiments of the invention as further described herein.

In another non-limiting, exemplary embodiment, a computer program product comprises program instructions embodied on a tangible computer-readable medium. Execution of the program instructions results in operations comprising: determining whether an active wireless communication connection has failed by using a radio link failure counter that operates as a function of a discontinuous reception schedule of the active wireless communication connection; and in response to determining that the active wireless communication connection has failed, performing at least one predefined action.

A computer program product as above, and further comprising one or more of the various aspects of the exemplary embodiments of the invention as further described herein.

In another non-limiting, exemplary embodiment, an apparatus comprising: a transceiver configured to communicate over an active wireless communication connection; and a processor configured to determine whether the active wireless communication connection has failed by using a radio link failure counter that operates as a function of a discontinuous reception schedule of the active wireless communication connection, wherein the processor is further configured, in response to determining that the active wireless communication connection has failed, to perform at least one predefined action.

An apparatus as above, and further comprising one or more of the various aspects of the exemplary embodiments of the invention as further described herein.

In another non-limiting, exemplary embodiment, an apparatus comprising: means for communicating over an active wireless communication connection; means for determining whether the active wireless communication connection has failed by using a means for counting that operates as a function of a discontinuous reception schedule of the active wireless communication connection; and means for performing at least one predefined action in response to determining that the active wireless communication connection has failed.

An apparatus as above, and further comprising one or more of the various aspects of the exemplary embodiments of the invention as further described herein.

In accordance with another non-limiting exemplary embodiment of the invention there is a method, executable computer program, and apparatus for implementing a radio link failure counter that operates as a function of a discontinuous reception schedule of an active wireless communication connection, and based on a value of the radio link failure counter, determining a condition of the active wireless communication connection. The method, executable computer program, and apparatus, as in any above where in response to determining the condition of the active wireless communication connection, performing at least one predefined action. The method, executable computer program, and apparatus as in any above where the determined condition is that the active wireless communication connection has failed. Further, a method executable computer program, and apparatus as in any above, wherein the radio link failure counter is one of incremented or decremented in response to an occurrence of a trigger and wherein the trigger comprises an event or condition linked to the discontinuous reception schedule. The executable computer program, and apparatus as in any above, wherein the active wireless communication connection utilizes an automatic repeat request or a hybrid automatic repeat request and wherein the radio link failure counter comprises a timer. Further a method, executable computer program, and apparatus as in any above wherein the active wireless communication connection is determined to have failed when the radio link failure counter equals or exceeds a maximum value or the radio link failure counter equals or falls below a minimum value and wherein the radio link failure counter corresponds to whether the discontinuous reception schedule in use comprises a short discontinuous reception or a long discontinuous reception. A method, executable computer program, and apparatus as in any above where in response to determining that the active wireless communication connection has failed, there may be reverting to a predefined discontinuous reception period. The method, executable computer program, and apparatus, as in any above, implemented in a user equipment or terminal.

### VI. Further Considerations

The exemplary embodiments of the invention, as discussed above and as particularly described with respect to exemplary methods, may be implemented as a computer program product comprising program instructions embodied on a tangible computer-readable medium. Execution of the program instructions results in operations comprising steps of utilizing the exemplary embodiments or steps of the method.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the invention, and not in limitation thereof.

1. A method comprising:
implementing a radio link failure counter that operates as a function of a discontinuous reception schedule of an active wireless communication connection; and
based on a value of the radio link failure counter, determining a condition of the active wireless communication connection.

2. The method of claim 1, further comprising:
in response to determining the condition of the active wireless communication connection, performing at least one predefined action.

3-35. (canceled)

36. The method of claim 1, wherein the determined condition is that the active wireless communication connection has failed.

37. The method of claim 1, wherein the active wireless communication connection is determined to have failed when the radio link failure counter equals or exceeds a maximum value or the radio link failure counter equals or falls below a minimum value.

38. The method of claim 37, further comprising:
in response to determining a condition that the active wireless communication connection has failed, reverting to a predefined discontinuous reception period.

39. The method of claim 1, wherein the radio link failure counter is one of incremented or decremented in response to an occurrence of a trigger.

40. The method of claim 39, wherein the trigger comprises an event or condition linked to the discontinuous reception schedule.

41. The method of claim 1, wherein the active wireless communication connection utilizes an automatic repeat request or a hybrid automatic repeat request.

42. The method of claim 1, wherein the radio link failure counter corresponds to whether the discontinuous reception schedule in use comprises a short discontinuous reception or a long discontinuous reception.

43. An apparatus comprising:
at least one processor; and
at least one memory including computer program code the at least one memory and the computer program code configured to, with the at least one processor, cause the apparatus to perform at least the following:
implementing a radio link failure counter that operates as a function of a discontinuous reception schedule of an active wireless communication connection; and
based on a value of the radio link failure counter, determining a condition of the active wireless communication connection.

44. The apparatus of claim 43, wherein the computer program code is further configured to cause the apparatus to perform:
in response to determining the condition of the active wireless communication connection, performing at least one predefined action.

45. The apparatus of claim 43, further comprising:
a receiver and a transmitter configured to communicate over the active wireless communication connection;
wherein the transmitter is configured to signal the discontinuous reception schedule to a user equipment.

46. The apparatus of claim 43, wherein the radio link failure counter is one of incremented or decremented in response to the occurrence of a trigger.

47. The apparatus of claim 46, wherein the trigger comprises an event or condition linked to the discontinuous reception schedule.

48. The apparatus of claim 43, wherein the active wireless communication connection utilizes an automatic repeat request or a hybrid automatic repeat request.

49. The apparatus of claim 43, wherein the computer program code is further configured to cause the apparatus to perform: determining a condition that the active wireless communication link has failed when the radio link failure counter equals or exceeds a maximum value or the radio link failure counter equals or falls below a minimum value.

50. The apparatus of claim 49, wherein the computer program code is further configured to cause the apparatus to perform: in response to determining the condition that the active wireless communication connection has failed, reverting to a predefined discontinuous reception period.

51. The apparatus of claim 43, wherein the radio link failure counter corresponds to whether the discontinuous reception schedule in use comprises a short discontinuous reception or a long discontinuous reception.

52. A computer readable medium encoded with a computer program executable by a processor to perform actions comprising:
implementing a radio link failure counter that operates as a function of a discontinuous reception schedule of an active wireless communication connection; and
based on a value of the radio link failure counter, determining determining a condition of the active wireless communication connection.
